(19) United States
(12) Patent Application Publication
(10) Pub. No.: US 2012/0025137 A1
(43) Pub. Date: Feb. 2, 2012

(54) CORE/SHELL LANTHANUM CERIUM TERBIUM PHOSPHATE, PHOSPHOR CONTAINING SAID PHOSPHATE, AND PREPARATION METHODS

(75) Inventors: Valérie Buisette, Paris (FR); Thierry Le-Mercier, Rosny-sous-Bois (FR)

(73) Assignee: RHODIA OPERATIONS, Aubervilliers (FR)

(21) Appl. No.: 13/259,331

(22) PCT Filed: Mar. 16, 2010
(86) PCT No.: PCT/EP2010/053342

§ 371 Date: Sep. 23, 2011

(30) Foreign Application Priority Data
Mar. 24, 2009 (FR) 0901373

(51) Int. Cl. C09K 11/81

(52) U.S. Cl. 252/301.4 P

(57) ABSTRACT

A phosphate containing particles including a mineral core and a lanthanum cerium terbium phosphate shell uniformly coating the mineral core with a thickness greater than or equal to 300 nm is described. The particles can have a mean diameter between 3 μm and 6 μm and the lanthanum cerium terbium phosphate can have the following general formula (1): La_{(1-x-y)}CeₓTb_{y}PO₄ (1), wherein x and y comply with the following conditions: 0.4≦x≦0.7 and 0.13≦y≦0.17. A phosphor including the above-described phosphate is also described.

The present invention relates to a lanthanum cerium terbium phosphate, of the core/shell type, to a phosphor comprising this phosphate and to methods of preparing them.

Mixed lanthanum cerium terbium phosphates, denoted hereafter by LaCeTb phosphates, are well known for their luminescence properties. They emit a bright green light when they are irradiated by certain high-energy radiation having wavelengths shorter than those in the visible range (UV or VUV radiation for lighting or display systems). Phosphors that exploit this property are commonly used on an industrial scale, for example in trichromatic fluorescent lamps, in backlighting systems for liquid crystal displays or in plasma systems.

These phosphors contain rare earths, the cost of which is high and also subject to large fluctuations. Reducing the cost of these phosphors therefore constitutes a major challenge.

For this purpose, core/shell phosphors have been developed which comprise a core made of a non-phosphor material and only the shell of which contains rare earths or the most expensive rare earths. By virtue of this structure, the amount of rare earths in the phosphor is reduced. Phosphors of this type are described in WO 2008/012266.

Moreover, apart from the need for lower-cost products, it is also sought to provide fine phosphors since the processing of fine products has the advantage of being easier, at least in certain applications, for example in certain trichromatic lamps. However, it is known that a fine product size may disturb and reduce the luminescence properties of such products.

The object of the invention is to provide phosphors which exhibit a good compromise between size and luminescence properties.

For this purpose, the phosphate of the invention is of the type comprising particles consisting of a mineral core and of a shell based on a lanthanum cerium terbium phosphate and homogeneously covering the mineral core over a depth equal to or greater than 300 nm, and it is characterized in that the particles have a mean diameter of between 3 and 6 μm and in that the lanthanum cerium terbium phosphate satisfies the following general formula (1):

La_{(1-x-y)}CeₓTb_{y}PO₄ (1)

in which x and y satisfy the following conditions:
0.4≦x≦0.7; and
0.13≦y≦0.17.

The invention also relates to a phosphor which is characterized in that it comprises a phosphate of the type described above.

Because of the specific combination of its features, the phosphor of the invention has a fine particle size and luminescence properties that are generally comparable to those of known core/shell phosphors.

Other features, details and advantages of the invention will become even more fully apparent on reading the following description and from the appended drawing in which:

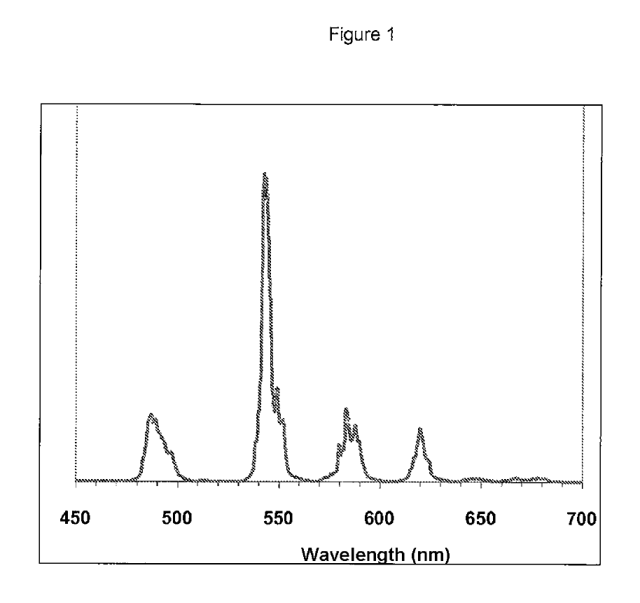

FIG. 1 is an emission spectrum of a phosphor according to the invention.

It should also be pointed out that, in the rest of the description, unless otherwise indicated, in all the ranges or limits of values given, the values at the bounds are included, the ranges or limits of values thus defined therefore covering any value at least equal to and greater than the lower bound and/or at most equal to or less than the upper bound.

The term “rare earth” is understood in the rest of the description to mean elements of the group formed by yttrium and those elements of the periodic table having an atomic number between 57 and 71 inclusive.

The term “specific surface area” is understood to mean the BET specific surface area determined by krypton adsorption. The surface areas given in the present description were measured on an ASAP2010 instrument after degassing the powder for 8 h at 200° C.

As mentioned above, the invention relates to two types of product: phosphates which in the rest of this description may also be called “precursors”; and phosphors obtained from these phosphates or precursors. The phosphors themselves have luminescence properties sufficient for rendering them directly usable in the desired applications. The precursors do not have luminescence properties or they do possibly have luminescence properties but these are too low for use in these same applications.

These two types of product will now be described in more detail. It is mentioned here that it is possible to refer in general to the teaching of WO 2008/012266 which relates to products having the same structure and which therefore applies to the present description unless otherwise more specifically or more particularly indicated.

### Phosphates or Precursors

The phosphates of the invention are firstly characterized by their specific core/shell structure which is described below.

The mineral core is based on a material which may especially be an oxide or a phosphate.

Among oxides, mention may in particular be made of zirconium oxide, zinc oxide, titanium oxide, magnesium oxide, aluminum oxide (alumina) and oxides of rare earths. As rare-earth oxide, gadolinium oxide, yttrium oxide and cerium oxide may be even more particularly mentioned.

The oxides preferably chosen may be yttrium oxide, gadolinium oxide and alumina.

Among phosphates, mention may be made of the phosphates (orthophosphates) of one or more rare earths, one of them possibly acting as a dopant, such as lanthanum orthophosphate (LaPO₄), lanthanum cerium orthophosphate ((LaCe)PO₄), yttrium orthophosphate (YPO₄), gadolinium orthophosphate (GdPO₄) and rare-earth or aluminum polyphosphates.

According to one particular embodiment, the material of the core is a lanthanum orthophosphate, a gadolinium orthophosphate or an yttrium orthophosphate.

Mention may also be made of alkaline-earth phosphates, such as Ca₂P₂O₇, zirconium phosphate ZrP₂O₇ and alkaline-earth hydroxyapatites.

Other mineral compounds such as vanadates, especially rare-earth vanadates (such as YVO₄), germanates, silica, silicates, especially zinc or zirconium silicate, tungstates, molybdates, sulfates (such as BaSO₄), borates (such as YBO₃, GdBO₃), carbonates and titanates (such as BaTiO₃), zirconates, and alkaline-earth metal aluminates, optionally doped by a rare earth, such as barium and/or magnesium aluminates, such as MgAl₂O₄, BaAl₂O₄ or BaMgAl₁₀O₁₇, are furthermore suitable.

Finally, compounds derived from the above compounds may be suitable, such as mixed oxides, especially rare-earth oxides, for example mixed zirconium cerium oxides, mixed phosphates, especially mixed rare-earth phosphates, and, more particularly, cerium, yttrium, lanthanum and gadolinium phosphates, and phosphovanadates.

In particular, the material of the core may have particular optical properties, especially UV reflection properties.

The expression “the mineral core is based on” is understood to denote an assembly comprising at least 50%, preferably at least 70%, more preferably at least 80% or even 90% by weight of the material in question. According to one particular embodiment, the core may essentially consist of said material (namely in a content of at least 95% by weight, for example at least 98% or even at least 99% by weight) or even entirely consist of this material.

Several advantageous embodiments of the invention will now be described below.

According to a first embodiment, the core is made of a dense material, corresponding in fact to a generally well crystallized material or else to a material having a low specific surface area.

The expression “low specific surface area” is understood to mean a specific surface area of at most 5 m²/g, more particularly at most 2 m²/g, even more particularly at most 1 m²/g and especially at most 0.6 m²/g.

According to another embodiment, the core is based on a temperature-stable material. By this is meant a material which has a melting point at a high temperature, which does not degrade into a by-product which would be problematic for the application as a phosphor at this same temperature, and which remains crystalline, therefore not being transformed into an amorphous material, again at this same temperature. The high temperature intended here is a temperature at least above 900° C., preferably at least above 1000° C. and even more preferably at least 1200° C.

The third embodiment consists in using for the core a material that combines the features of the above two embodiments, therefore a temperature-stable material having a low specific surface area.

The fact of using a core according to at least one of the embodiments described above has a number of advantages. Firstly, the core/shell structure of the precursor is particularly well maintained in the phosphor that results therefrom, enabling a maximum cost advantage to be achieved.

Moreover, it has been found that the phosphors obtained from the precursors of the invention, in the manufacture of which a core according to at least one of the aforementioned embodiments was used, have photoluminescence efficiencies not only identical but in certain cases superior to those of a phosphor of the same composition but not having a core/shell structure.

The materials of the core may be densified, especially by using the known molten salt technique. This technique consists in bringing the material to be densified to a high temperature, for example at least 900° C., optionally in a reducing atmosphere, for example an argon/hydrogen mixture, in the presence of a fluxing agent, which may be chosen from chlorides (for example sodium chloride or potassium chloride), fluorides (for example lithium fluoride), borates (lithium borate), carbonates and boric acid.

The core may have a mean diameter of especially between 1 and 5.5 μm, more particularly between 2 and 4.5 μm.

These diameters may be determined by SEM (scanning electron microscopy) with statistical counting of at least 150 particles.

The dimensions of the core, and likewise those of the shell that will be described below, may also be measured on TEM (transmission electron microscopy) micrographs of sections of compositions/precursors of the invention.

The other structural feature of the compositions/precursors of the invention is the shell.

This shell covers the core homogeneously over a thickness which is equal to or greater than 300 nm. The term “homogeneous” is understood to mean a continuous layer completely covering the core and having a thickness which is preferably never less than 300 nm. Such homogeneity is especially visible on scanning electron micrographs. X-ray diffraction (XRD) measurements furthermore demonstrate the presence of two separate compositions, that of the core and that of the shell.

The thickness of the layer may be more particularly at least 500 nm. It may also be equal to or less than 2000 nm (2 μm), more particularly equal to or less than 1000 nm.

The phosphate present in the shell satisfies the following general formula (1):

La_{(1-x-y)}CeₓTb_{y}PO₄ (1)

in which x and y satisfy the following conditions:
0.4≦x≦0.7; and
0.13≦y≦0.17.

More particularly, the lanthanum cerium terbium phosphate of the shell may satisfy the general formula (1) in which x satisfies the condition 0.43≦x≦0.60 and more particularly 0.45≦x≦0.60.

More particularly too, the lanthanum cerium terbium phosphate of the shell may satisfy the general formula (1) in which y satisfies the condition 0.13≦y≦0.16 and more particularly 0.15≦y≦0.16.

The invention also covers the more particular embodiment in which x and y satisfy the two particular conditions given above at the same time.

It should be noted that it is not excluded for the shell to be able to comprise other residual phosphate-containing species.

The shell may comprise, with the LaCeTb phosphate, other elements conventionally acting in particular as a promoter of or dopant for the luminescence properties or as a stabilizer, for stabilizing the oxidation states of the elements cerium and terbium. As examples of such other elements, boron and other rare earths, especially scandium, yttrium, lutetium and gadolinium, may be more particularly mentioned. The aforementioned rare earths may be more particularly present as substitutes for the element lanthanum. These doping or stabilizing elements are present in an amount of generally at most 1% by weight of element relative to the total weight of the phosphate of the invention in the case of boron and generally at most 30% in the case of the other elements mentioned above.

It should be pointed out that usually in precursor particles, substantially all the LaCeTb phosphate is localized in the layer surrounding the core.

The phosphates of the invention are also characterized by their particle size.

Specifically, they consist of particles generally having a mean size of between 3 μm and 6 μm, more particularly between 3 μm and 5 μm.

The mean diameter referred to is the volume average of the diameters of a population of particles.

The particle sizes given here, and for the rest of the description, are measured by means of a Malvern laser particle size analyzer on a sample of particles dispersed in water by ultrasound (130 W) for 1 minute 30 seconds.

Furthermore, the particles preferably have a low dispersion index, typically at most 0.6 and preferably at most 0.5.

The term “dispersion index” for a population of particles is understood to mean, in the context of the present description, the ratio I as defined below:

I=(Ø₈₄−Ø₁₆)/(2×Ø₅₀),

where: Ø₈₄ is the diameter of the particles for which 84% of the particles have a diameter below Ø₈₄; Ø₁₆ is the diameter of the particles for which 16% of the particles have a diameter below Ø₁₆; and Ø₅₀ is the mean diameter of the particles, for which diameter 50% of the particles have a diameter below Ø₅₀.

This definition of the dispersion index, given here for the precursor particles, also applies, for the rest of the description, to the phosphors.

Although the phosphates/precursors according to the invention may possibly have luminescence properties after exposure to certain wavelengths, it is possible, and even necessary, for these luminescence properties to be further improved by carrying out post-treatments on these products, so as to obtain true phosphors that can be used directly as such in the desired application.

It will be understood that the boundary between a precursor and an actual phosphor remains arbitrary and depends on just the luminescence threshold above which it is considered that a product can be used directly and acceptably by a user.

In the present case, and quite generally, phosphates according to the invention that have not been subjected to heat treatments above about 900° C. may be considered and identified as phosphor precursors since such products generally have luminescence properties that may be judged as not meeting the minimum brightness criterion for commercial phosphors that can be used directly as such, without any subsequent transformation. Conversely, products which, possibly after having been subjected to appropriate treatments, develop suitable brightnesses, sufficient for being used directly by an applicator, for example in lamps, may be termed phosphors.

The phosphors according to the invention are described below.

### Phosphors

The phosphors of the invention consist of, or comprise, the phosphates of the invention as described above.

Thus, everything described above with regard to these phosphates likewise applies here as regards the description of the phosphors according to the invention. In particular, this applies to all the features given above regarding the structure formed by the mineral core and the homogeneous shell, as regards the nature of the mineral core, as regards that of the shell and especially that of the LaCeTb phosphate and also the particle size features.

As will be seen below, the phosphors of the invention are obtained from phosphate/precursors by a heat treatment, which has the consequence of not substantially modifying the features of these phosphates as mentioned above.

The methods of preparing the phosphates and the phosphors of the invention are described below.

### Methods of Preparation

The method of preparing the phosphates of the invention is characterized in that it comprises the following steps:
(a) an aqueous solution of soluble lanthanum, cerium and terbium salts is steadily and continuously added to a starting aqueous medium having an initial pH of between 1 and 5 and comprising particles in the dispersed state of the aforementioned mineral core and phosphate ions, while maintaining the pH of the reaction medium at a substantially constant value, thereby obtaining particles comprising a mineral core on the surface of which a mixed lanthanum cerium terbium phosphate is deposited; and then
(b) the particles obtained are separated from the reaction medium and are heat-treated at a temperature between 400 and 900° C.

The very specific conditions of the method of the invention result, at the end of step (b), in a preferential (and in most cases quasi-exclusive, or even exclusive) localization of the LaCeTb phosphate formed on the surface of the core particles, in the form of a homogeneous shell.

The mixed LaCeTb phosphate may precipitate to form different morphologies. Depending on the preparation conditions, the formation of acicular particles forming a homogeneous covering on the surface of the mineral core particles (a morphology known as a “sea urchin spine” morphology) or the formation of spherical particles (a morphology known as “cauliflower” morphology) may especially be observed.

Under the effect of the heat treatment of step (b), the morphology is essentially retained.

Various features and advantageous embodiments of the method of the invention and of the precursors and phosphors will now be described in greater detail.

In step (a) of the method of the invention, an LaCeTb phosphate is precipitated directly, while maintaining the pH, by reacting the solution of soluble lanthanum, cerium and terbium salts with the starting aqueous medium containing phosphate ions.

Moreover, the precipitation of step (a) is characteristically carried out in the presence of mineral core particles initially present in the dispersed state in the starting medium, to the surface of which the mixed phosphate which precipitates attaches, said particles generally being maintained in the dispersed state throughout step (a), typically by keeping the medium stirred.

It is advantageous to use particles having an isotropic, preferably substantially spherical, morphology.

In step (a) of the method of the invention, the order of introducing the reactants is important.

In particular, the solution of the soluble rare-earth salts must specifically be introduced into a starting medium that initially contains the phosphate ions and the mineral core particles.

In this solution, the concentrations of the lanthanum, cerium and terbium salts may vary between wide limits. Typically, the total concentration of the three rare earths may be between 0.01 mol/liter and 3 mol/liter.

Suitable soluble lanthanum, cerium and terbium salts in the solution are especially water-soluble salts, such as for example nitrates, chlorides, acetates, carboxylates or a mixture of these salts. According to the invention, preferred salts are nitrates. These salts are present in the necessary stoichiometric quantities.

The solution may additionally comprise other metal salts, such as for example salts of other rare earths, of boron or of other elements of the dopant, promoter or stabilizer type that were mentioned above.

The phosphate ions initially present in the starting medium and intended to be reacted with the solution may be introduced into the starting medium in the form of pure compounds or compounds in solution, such as for example phosphoric acid, alkali metal phosphates or phosphates of other metallic elements forming a soluble compound with the anions associated with the rare earths.

According to a preferred embodiment of the invention, the phosphate ions are initially present in the starting mixture in the form of ammonium phosphates. According to this embodiment, the ammonium cation decomposes during the heat treatment of step (b), thus making it possible to obtain a high-purity mixed phosphate. Among the ammonium phosphates, diammonium phosphate and monoammonium phosphate are particularly preferred compounds for implementing the invention.

The phosphate ions are advantageously introduced in stoichiometric excess into the starting medium, relative to the total amount of lanthanum, cerium and terbium present in the solution, i.e. with an initial phosphate/(La+Ce+Tb) molar ratio greater than 1, preferably between 1.1 and 3, this ratio typically being less than 2, for example between 1.1 and 1.5.

According to the method of the invention, the solution is gradually and continuously introduced into the starting medium.

Moreover, according to another important feature of the method of the invention, which makes it possible in particular to obtain a homogeneous coating of the mineral core particles by the LaCeTb phosphate, the initial pH (pH⁰) of the solution containing the phosphate ions is between 1 and 5, more particularly between 1 and 2. Furthermore, preferably it is subsequently kept substantially at this pH⁰ value throughout the duration of addition of the solution.

The expression “pH maintained at a substantially constant value” is understood to mean that the pH of the medium will vary by at most 0.5 pH units about the setpoint value set, and more preferably by at most 0.1 pH units about this value.

To achieve these pH values and to ensure that the required pH can be maintained, it is possible to add to the starting medium basic or acidic compounds or buffer solutions, prior to and/or simultaneously with the introduction of the solution.

As suitable basic compounds according to the invention, mention may be made, by way of example, of metal hydroxides (NaOH, KOH, Ca(OH)₂, etc.) or else ammonium hydroxide, or any other basic compound of which the species that constitute it will not form any precipitate during their addition into the reaction medium, by combination with one of the species furthermore contained in this medium, and that allow the pH of the precipitation medium to be maintained.

Moreover, it should be noted that the precipitation in step (a) is carried out in an aqueous medium, generally using water as the only solvent. However, according to another conceivable embodiment, the medium of step (a) may optionally be an aqueous-alcoholic medium, for example a water/ethanol medium.

Furthermore, the processing temperature of step (a) is generally between 10° C. and 100° C.

Step (a) may further include a maturing step, at the end of the addition of all of the solution and prior to step (b). In this case, the maturing is advantageously carried out by leaving the resulting medium stirred at the reaction temperature, advantageously for at least 15 minutes after the end of addition of the solution.

In step (b), the surface-modified particles as obtained at the end of step (a) are firstly separated from the reaction medium. These particles may be easily recovered at the end of step (a), by any means known per se, in particular by simple filtration, or optionally by other types of solid/liquid separation. Indeed, under the conditions of the method according to the invention, a supported mixed LaCeTb phosphate is precipitated which is not gelatinous and can be easily filtered.

The recovered particles may then be advantageously washed, for example with water, for the purpose of ridding them of possible impurities, especially adsorbed nitrate and/or ammonium groups.

At the end of these separation and if necessary washing steps, step (b) includes a specific heat treatment step at a temperature between 400 and 900° C. This heat treatment comprises a calcination, usually in air, preferably carried out at a temperature of at least 600° C., advantageously between 700 and 900° C.

After this treatment, a phosphate or a precursor according to the invention is obtained.

The method of preparing a phosphor according to the invention comprises a heat treatment, at a temperature of above 900° C. and advantageously at least around 1000° C., of the phosphate as obtained by the method described above.

Although the precursor particles may themselves have intrinsic luminescence properties, these properties are greatly improved by this heat treatment.

A consequence of this heat treatment is especially to convert all the Ce and Tb species to their (+III) oxidation state. It may be carried out using means known per se for the heat treatment of phosphors, in the presence or absence of a fluxing agent (also known as a “flux”), with or without a reducing atmosphere, depending on the case.

The precursor particles of the invention have the particularly remarkable property of not clumping during the calcination, that is to say they do not generally have a tendency to agglomerate and therefore to end up in a final form consisting of coarse aggregates having a size of 0.1 to several mm for example; it is therefore not necessary to carry out prior milling of the powders before they are subjected to the conventional treatments intended for obtaining the final phosphor, this constituting yet another advantage of the invention.

According to a first variant, the heat treatment is carried out by subjecting the precursor particles to a heat treatment in the presence of a flux.

By way of flux, mention may be made of lithium fluoride, lithium tetraborate, lithium chloride, lithium carbonate, lithium phosphate, potassium chloride, ammonium chloride, boron oxide, boric acid and ammonium phosphates, and also mixtures thereof.

The flux is mixed with the phosphate particles to be treated, and then the mixture is heated to a temperature preferably between 1000° C. and 1300° C.

The heat treatment may be carried out in a reducing atmosphere (H₂, N₂/H₂ or Ar/H₂ for example) or not in a reducing atmosphere (N₂, Ar or air).

According to a second variant of the method, the phosphate particles are subjected to the heat treatment in the absence of flux.

This variant may, in addition, be either carried out in a reducing atmosphere or a nonreducing atmosphere, in particular in an oxidizing atmosphere such as for example air, without having to use expensive reducing atmospheres. Of course, it is quite possible, although less economical, to also use, still within the scope of this second variant, reducing or nonreducing atmospheres.

One specific embodiment of the method of preparing the phosphor consists in treating the precursor at a temperature of 1000 to 1300° C. in an argon/hydrogen atmosphere.

This type of treatment is known in itself, and conventionally used in phosphor production processes, especially for adapting the phosphors to the desired application (morphology of the particles, surface state, brightness, for example).

After treatment, the particles are advantageously washed, so as to obtain a phosphor that is as pure as possible and is in a deagglomerated state or slightly agglomerated state. In the latter case, it is possible to deagglomerate the phosphor by making it undergo a deagglomeration treatment under mild conditions.

The aforementioned heat treatments make it possible to obtain phosphors which retain a core/shell structure and a particle size distribution that are very close to those of the particles of the precursor phosphate.

Moreover, the heat treatment may be carried out without inducing phenomena that are sensitive to the diffusion of the Ce and Tb species from the outer phosphor layer toward the core.

According to one specific conceivable embodiment of the invention, it is possible to carry out, in one and the same step, the heat treatments of step (b), for converting the phosphate into a phosphor. In this case, the phosphor is obtained directly, without stopping at the precursor stage.

The phosphors of the invention have improved photoluminescence properties.

The phosphors of the invention have intense luminescence properties for electromagnetic excitations corresponding to the various absorption fields of the product.

Thus, the phosphors of the invention may be used in lighting or display systems having an excitation source in the UV (200-280 nm) range, for example around 254 nm, notably, in particular, trichromatic mercury vapor lamps, for example of the tubular type, and lamps for the backlighting of liquid-crystal systems in tubular or planar form (LCD backlighting). They have a high brightness under UV excitation, and an absence of luminescence loss following a heat post-treatment. Their luminescence is in particular stable under UV at relatively high temperatures between room temperature and 300° C.

The phosphors of the invention are good green phosphors for VUV (or “plasma”) excitation systems, such as for example for plasma screens and mercury-free trichromatic lamps, especially xenon excitation lamps (whether tubular or planar). The phosphors of the invention have a strong green emission under VUV excitation (for example around 147 nm and 172 nm). The phosphors are stable under VUV excitation.

The phosphors of the invention may also be used as green phosphors in LED (light-emitting diode) excitation devices. They may be especially used in systems that can be excited in the near UV.

They may also be used in UV excitation marking systems.

The phosphors of the invention may be applied in lamp and screen systems using well-known techniques, for example screen printing, spraying, electrophoresis or sedimentation.

They may also be dispersed in organic matrices (for example matrices made of plastics or polymers that are transparent under UV, etc.), inorganic (for example silica) matrices or organic-inorganic hybrid matrices.

The invention also relates, according to another aspect, to the luminescent devices of the aforementioned type that comprise, as green luminescence source, the phosphors as described above or the phosphors obtained from the method also described above.

Examples will now be given.

In the following examples, the particles prepared have been characterized in terms of particle size, morphology and composition using the following methods.

### Particle Size Measurement

The particle diameters were determined using a laser particle size analyzer (Malvern 2000) on a sample of particles dispersed in water by ultrasound (130 W) for 1 minute 30 seconds.

### Electron Microscopy

Micrographs were obtained using transmission electron microscopy on a microtomed section of the particles using a high-resolution JEOL 2010 FEG TEM microscope. The spatial resolution of the instrument for the chemical composition measurements by EDS (energy dispersion spectroscopy) was <2 nm. By correlating the observed morphologies and the measured chemical compositions, it was possible to demonstrate the core/shell structure and to measure the thickness of the shell on the micrographs.

The chemical composition measurements were also carried out by EDS on micrographs produced by HAADF-STEM. The measurement corresponded to an average taken over at least two spectra.

### X-Ray Diffraction

The X-ray diffractograms were produced using the K_{α} line with copper as anticathode according to the Bragg-Brentano method. The resolution was chosen so as to be sufficient to separate the LaPO₄:Ce,Tb line from the LaPO₄ line, preferably this resolution was Δ(2θ)<0.02°.

### EXAMPLE 1

This example relates to the synthesis of an LaPO₄ core.

Added to 500 ml of a phosphoric acid (H₃PO₄) solution (1.725 mol/l), brought beforehand to pH 1.9 by addition of ammonium hydroxide and heated to 60° C., were 500 ml of a lanthanum nitrate solution (1.5 mol/l). The pH during precipitation was adjusted to 1.9 by addition of ammonium hydroxide.

After the precipitation step, the reaction medium was again held for 1 h at 60° C. The precipitate was then recovered by filtration, washed with water and then dried at 60° C. in air. The powder obtained was then subjected to a heat treatment at 900° C. in air.

The product thus obtained, characterized by X-ray diffraction, was a lanthanum orthophosphate LaPO₄ of monazite structure.

The powder was then mixed with 1% by weight of an LiF powder, and then calcined for 2 h at 1100° C. in a reducing atmosphere. Next, the product obtained was milled and then washed by being resuspended in hot water at 80° C. for 3 h with stirring. Finally, the suspension was filtered and dried.

This then resulted in a lanthanum phosphate of monazite phase having a mean particle size D₅₀, measured by Malvern laser particle size analysis, of 4.3 μm with a dispersion index of 0.4. Its specific surface area was 0.5 m²/g.

The mean diameter of the core thus obtained, measured by SEM, was 3.2 μm.

### COMPARATIVE EXAMPLE 2

This example relates to a phosphor according to the prior art.

A precursor was firstly prepared in the following manner.

In a 1 liter beaker, a solution of rare-earth nitrates (solution A) was prepared as follows: 29.37 g of a 2.8M (d=1.678 g/l) solution of La(NO₃)₃, 20.84 g of a 2.88M (d=1.715 g/l) solution of Ce(NO₃)₃ and 12.38 g of a 2M (d=1.548) solution of Tb(NO₃)₃ and 462 ml of deionized water were mixed, making a total of 0.1 mol of rare-earth nitrates of the composition (La_{0.49}Ce_{0.35}Tb_{0.16})(NO₃)₃.

Introduced into a 2 liter reactor were (solution B) 340 ml of deionized water, to which 13.27 g of Normapur 85% H₃PO₄ (0.115 mol) were added. The solution was heated to 60° C. and 28% ammonium hydroxide NH₄OH was added in order to attain a pH of 1.5. Next, 23.4 g of a lanthanum phosphate from Example 1 were added to the stock thus prepared.

The previously prepared solution A was added with stirring to the mixture over 1 hour, at temperature (60° C.) and under 1.5 pH control. The mixture obtained was matured for 1 h at 60° C. At the end of the maturing step, the mixture was left to cool down to 30° C. and the product recovered. It was then filtered over sintered glass and washed with two volumes of water, then dried and calcined for 2 h at 900° C. in air.

A rare-earth phosphate of monazite phase of the core/shell type was then obtained that had two monazite crystalline phases of separate compositions, namely LaPO₄ and (La,Ce,Tb)PO₄. The particle size (D₅₀) was 6.0 μm, with a dispersion index of 0.5.

A TEM micrograph was taken of the resin-coated product prepared by ultramicrotomy (thickness ˜100 nm) and placed on a perforated membrane. The particles were seen in cross section. In this micrograph, a particle section can be seen, the core of which is spherical and surrounded by a shell with an average thickness of 1.1 μm.

This precursor was then calcined at 1200° C. for 4 h under an Ar/H₂ (5% hydrogen) reducing atmosphere so as to obtain the control comparative phosphor.

The efficiency of the phosphor measured by the photo-luminescence yield (PL) of this phosphor was determined by integrating the emission spectrum under 254 nm excitation, measured using a spectrofluorometer in the 450 nm to 700 nm wavelength range. It was normalized to 100%.

The efficiency measurements of the phosphors of the invention were measured in relative value with respect to the luminous efficiency of the comparative example.

### EXAMPLE 3

This example relates to the preparation of a precursor according to the invention.

A solution of rare-earth nitrates (solution A) was prepared as follows in a 1 liter reactor: 203.4 g of a 454 g/l La(NO₃)₃ solution, 215 g of a 496 g/l Ce(NO₃)₃ solution and 100.3 g of a 447 g/l Tb(NO₃)₃ solution were mixed with 114.4 ml of deionized water, making a total of 0.84 mol of rare-earth nitrates with the composition (La_{0.40}Ce_{0.43}Tb_{0.17})(NO₃)₃.

Introduced into a 2.5 liter reactor were (solution B) 1.1 l of deionized water to which 115.7 g of 85% Normapur H₃PO₄ were added. The solution was heated to 60° C. 12N ammonium hydroxide was added to obtain a pH of 1.5. Next, added to the stock thus prepared, were 131 g of a lanthanum phosphate from Example 1.

The previously prepared solution A was then added with stirring to the mixture over 1 hour, at temperature (60° C.) and under 1.5 pH control. The mixture obtained was matured for 1 h at 60° C.

It was left to cool down to 30° C. and the product was recovered. It was then filtered over sintered glass and washed with two volumes of water, then dried and calcined for 2 h at 900° C. in air.

A core/shell type rare-earth phosphate of monazite phase was therefore obtained. The XRD diffractograms showed the presence of two monazite crystalline phases of different compositions, namely LaPO₄ and (La,Ce,Tb)PO₄.

The product had a mean size (D₅₀), measured by Malvern laser particle size analysis, of 5.3 μm with a dispersion index of 0.3.

### EXAMPLE 4

This example relates to a phosphor according to the invention.

The precursor powder obtained in Example 3 was calcined for 4 h in an Ar/H₂ (5% hydrogen) atmosphere at 1200° C.

The mean particle size (D₅₀), measured by Malvern laser particle size analysis, was 5.3 μm with a dispersion index of 0.5.

### EXAMPLE 5

This example relates to the preparation of a precursor according to the invention.

A rare-earth nitrate solution (solution A) was prepared in a 1 liter reactor as follows: 259.7 g of a 454 g/l La(NO₃)₃ solution, 249.6 g of a 496 g/l Ce(NO₃)₃ solution and 92.7 g of a 447 g/l Tb(NO₃)₃ solution were mixed with 135 ml of deionized water, making a total of 0.98 mol of rare-earth nitrates with the composition (La_{0.44}Ce_{0.43}Tb_{0.13})(NO₃)₃.

Introduced into a 2.5 liter reactor were (solution B) 1 l of deionized water to which 135 g of 85% Normapur H₃PO₄ were added. The solution was heated to 60° C. and 12N ammonium hydroxide added in order to obtain a pH of 1.7. Next, added to the stock thus prepared were 98 g of a lanthanum phosphate from Example 1.

The previously prepared solution A was added with stirring to the mixture over 1 hour, at temperature (60° C.) and under 1.7 pH control. The mixture obtained was matured for 15 minutes at 60° C.

It was left to cool down to 30° C. and the product was recovered. Next, it was filtered over sintered glass and washed with two volumes of water, before being dried and calcined for 2 h at 900° C. in air.

A core/shell type rare-earth phosphate of monazite phase was therefore obtained. The XRD diffractograms showed the presence of two monazite crystalline phases having different compositions, namely LaPO₄ and (La,Ce,Tb)PO₄.

The product had a mean size (D₅₀), measured by Malvern laser particle size analysis, of 5.7 μm with a dispersion index of 0.3.

Analysis of a TEM micrograph taken under the same conditions as those described in Example 2 gave a shell thickness of 0.8 μm.

### EXAMPLE 6

This example relates to a phosphor according to the invention.

The precursor powder obtained from Example 4 was calcined for 4 h in an Ar/H₂ (5% hydrogen) atmosphere at 1200° C.

### EXAMPLE 7

This example relates to the preparation of a precursor according to the invention.

A rare-earth nitrate solution (solution A) was prepared in a 1 liter reactor as follows: 126.3 g of a 454 g/l La(NO₃)₃ solution, 299.9 g of a 496 g/l Ce(NO₃)₃ solution and 89.6 g of a 447 g/l Tb(NO₃)₃ solution were mixed with 117 ml of deionized water, making a total of 0.98 mol of rare-earth nitrates with the composition (La_{0.25}Ce_{0.60}Tb_{0.15})(NO₃)₃.

Introduced into a 2.5 liter reactor was (solution B) 1 liter of deionized water to which 115.7 g of 85% Normapur H₃PO₄ were added. The solution was heated to 60° C. and 12N ammonium hydroxide was added in order to obtain a pH of 1.8.

Next, added to the stock thus prepared were 131 g of a lanthanum phosphate from Example 1.

The previously prepared solution A was added with stirring to the mixture over 1 hour, at temperature (60° C.) and under 1.8 pH control. The mixture obtained was matured for 15 minutes at 60° C.

It was left to cool down to 30° C. and the product was recovered. Next, it was filtered over sintered glass and washed with two volumes of water, before being dried and calcined for 2 h at 900° C. in air.

A core/shell type rare-earth phosphate of monazite phase was therefore obtained. The XRD diffractograms showed the presence of two monazite crystalline phases having different compositions, namely LaPO₄ and (La,Ce,Tb)PO₄.

The product had a mean size (D₅₀), measured by Malvern laser particle size analysis, of 4.4 μm with a dispersion index of 0.3.

Analysis of a TEM micrograph taken under the same conditions as those described in Example 2 gave a shell thickness of 0.5 μm.

### EXAMPLE 8

This example relates to a phosphor according to the invention.

The precursor powder obtained from Example 7 was calcined for 4 h in an Ar/H₂ (5% hydrogen) atmosphere at 1200° C.

Table 1 below gives the characteristics of the phosphors of the above examples.

TABLE 1

| Example | x | y | PL | D₅₀ (μm) |
|---|---|---|---|---|
| 2 (comparative) | 0.35 | 0.16 | 100 | 6.2 |
| 4 | 0.43 | 0.17 | 103 | 5.3 |
| 6 | 0.43 | 0.13 | 102 | 5.9 |
| 8 | 0.60 | 0.15 | 103 | 4.9 |

In Table 1, x and y correspond to the indices x and y of formula (1) given above. It may therefore be seen that the phosphors according to the invention, although having a smaller particle size than the comparative product, have photoluminescence yields (PL) higher than said comparative product, the difference being significant given the type of measurements carried out here.

FIG. 1 is an emission spectrum of the phosphor from Example 4 under 254 nm excitation. This spectrum shows that the product emits strongly in the green.

1. A phosphate comprising particles comprising a mineral core and a shell comprised of a lanthanum cerium terbium phosphate and homogeneously covering the mineral core over a depth equal to or greater than 300 nm, wherein the particles have a mean diameter of between 3 μm and 6 μm and in that the lanthanum cerium terbium phosphate satisfies the following general formula (1):
La_{(1-x-y)}CeₓTb_{y}PO₄ (1)
in which x and y satisfy the following conditions:
0.4≦x≦0.7; and
0.13≦y≦0.17.

2. The phosphate as claimed in claim 1, wherein the lanthanum cerium terbium phosphate satisfies the general formula (1) in which x satisfies the condition 0.45≦x≦0.60.

3. The phosphate as claimed in claim 1, wherein the lanthanum cerium terbium phosphate satisfies the general formula (1) in which y satisfies the condition 0.13≦y≦0.16.

4. The phosphate as claimed in claim 1, wherein the mineral core of the particles is comprised of a phosphate or a mineral oxide.

5. A phosphor comprising a phosphate as claimed in claim 1.

6. A method of preparing a phosphate as claimed claim 1, the method comprising the following steps:
(a) adding an aqueous solution of soluble lanthanum, cerium and terbium salts to a starting aqueous medium having an initial pH of between 1 and 5 and comprising particles in a dispersed state of the aforementioned mineral core and phosphate ions, while maintaining the pH of the reaction medium at a substantially constant value, thereby obtaining particles comprising a mineral core on a surface of which a mixed lanthanum cerium terbium phosphate is deposited; and then
(b) separating the particles obtained from the reaction medium and heat treating the particles at a temperature between 400° C. and 900° C.

7. The method as claimed in claim 6, wherein, in step (a), the phosphate ions are introduced in stoichiometric excess into the starting aqueous medium, with an initial phosphate/(La+Ce+Tb) molar ratio of greater than 1.

8. The method of preparing a phosphor as claimed in claim 5, wherein the resulting phosphate is heat-treated at a temperature above 900° C.

9. A device selected from the group consisting of a plasma system; a trichromatic mercury vapor lamp; a lamp for backlighting liquid-crystal systems; a mercury-free trichromatic lamp; an LED excitation device; and a UV excitation marking system, wherein the device comprises, or is manufactured using, a phosphor as claimed in claim 5.

10. The phosphate as claimed in claim 4, wherein the core of the particles is comprised of a rare-earth phosphate or an aluminum oxide.

11. The method as claimed in claim 7, wherein the initial phosphate/(La+Ce+Tb) molar ratio is between 1.1 and 3.

12. The method as claimed in claim 8, wherein the phosphate is heat treated at a temperature of at least 1000° C.

13. A device selected from the group consisting of a plasma system; a trichromatic mercury vapor lamp; a lamp for backlighting liquid-crystal systems; a mercury-free trichromatic lamp; an LED excitation device; and a UV excitation marking system, wherein the device comprises, or is manufactured using a phosphor obtained by the method as claimed in claim 8.
